(19) United States
(12) Patent Application Publication
(10) Pub. No.: US 2015/0024738 A1
(43) Pub. Date: Jan. 22, 2015

(54) METHOD AND SYSTEM FOR CONTROLLING A WIRELESS RECEIVER

(71) Applicant: Motorola Solutions, Inc, Schaumburg, IL (US)

(72) Inventors: JEFF S. ANDERSON, Bloomingdale, IL (US); HEMANG F. PATEL, Hoffman Estates, IL (US)

(73) Assignee: Motorola Solutions, Inc, Schaumburg, IL (US)

(21) Appl. No.: 13/943,349

(22) Filed: Jul. 16, 2013

(51) Int. Cl. H04W 36/00

(52) U.S. Cl. CPC H04W 36/0066; H04W 36/0094
USPC 455/432.1; 455/437; 455/550.1

(57) ABSTRACT

A wireless receiver, and a method of controlling a wireless receiver. The wireless receiver comprises first and second antennas. The method comprises: receiving a first signal of a first network using both a first antenna and a second antenna and determining that a quality of the first signal is greater than a first threshold quality. In response to determining that the quality of the first signal is greater than the first threshold quality, the second antenna is used for scanning for a second signal of a second network while receiving the signal of the first network using the first antenna. The wireless receiver is configured to switch to the second network if a quality of the second signal is greater than a second threshold quality.

### BACKGROUND OF THE INVENTION

Recent advances in cellular technology, such as Long Term Evolution (LTE) networks developed by the 3rd Generation Partnership Project (3GPP), have transformed public safety communications. The advances enable better protection of first responders at an incident scene, such as police, fire and ambulance personnel, along with protection of the communities they serve.

Such advances enable decision makers in various locations to make decisions quickly and safely. Data on an LTE network can include, for example, streaming video of an incident scene, which can be made available to both first responders and coordination personnel. This enables efficient determination of risks, which facilitates good decision making, as well as enabling efficient communication between stakeholders and efficient coordination of resources.

In order to facilitate such public safety communications, dedicated public safety networks have been developed. Modern dedicated public safety networks are similar to that of their commercial counterparts, and can, for example, be based upon common standards such as 3GPP LTE.

Despite these great advances in cellular networking technology, coverage in dedicated public safety networks may not always be sufficient. While network coverage in dedicated public safety networks is continually increasing, there may be areas where network coverage is not sufficient, and thus interoperability with commercial networks is often used to extend a dedicated public safety network. When public safety professionals travel off of the dedicated public safety network, a commercial network is used instead.

A shortcoming of today's technology is that there is currently no efficient way for a terminal to move back to a dedicated public safety network after moving to a commercial network. As a result, roaming charges may be incurred despite the dedicated public safety network later coming into coverage again. Additionally, features of the dedicated public safety network, such as QoS capabilities, will often not be available to terminals connected to a commercial network.

Certain systems of the prior art include two complete receivers on public safety terminals, wherein one of the receivers can be used to scan for the dedicated public safety network while connected to a commercial network. Upon detection of the dedicated public safety network, the terminal is then able to move from the commercial network back to the dedicated public safety network.

A problem with including two complete receivers on public safety terminals is that a significant additional cost is required to implement the additional receiver. A further problem is that interference between the transceivers can cause degradation of signal quality, especially when the two receivers are operating at frequencies that are close to each other. An example of such a configuration where public safety frequencies are adjacent to commercial cellular frequencies is the US 700 MHz band.

Certain systems of the prior art enable measurement of another band by public safety terminals through provision of a network assisted gap. In such case, a small measurement gap, during which no ordinary transmission or reception occurs, is provided by the network. The public safety terminal is then able to switch to the dedicated public safety network momentarily and perform signal quality measurements.

A problem with network assisted gaps of the prior art is that they require network assistance, and many networks do not provide such assistance. A further problem is that measurement gaps are typically very short, e.g., on the order of a few milliseconds, which enables only coarse signal quality measurements.

Accordingly, there is a need for an improved method and system for controlling a wireless receiver.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless receiver, according to an embodiment of the present invention.

FIG. 2 illustrates a method of controlling a wireless receiver, according to an embodiment of the present invention.

FIG. 3 illustrates a method of controlling a wireless receiver, according to an alternative embodiment of the present invention.

FIG. 4 is a block diagram of a controller of a wireless device, according to an embodiment of the present invention.

FIG. 5 illustrates a method of scanning for channels, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

According to one aspect, the invention resides in a method of controlling a wireless receiver including first and second antennas, the method comprising: receiving a first signal of a first network using both a first antenna and a second antenna; determining that a quality of the first signal is greater than a first threshold quality; in response to determining that the quality of the first signal is greater than the first threshold quality, scanning for a second signal of a second network using the second antenna while receiving the signal of the first network using the first antenna; and switching to the second network if a quality of the second signal is greater than a second threshold quality.

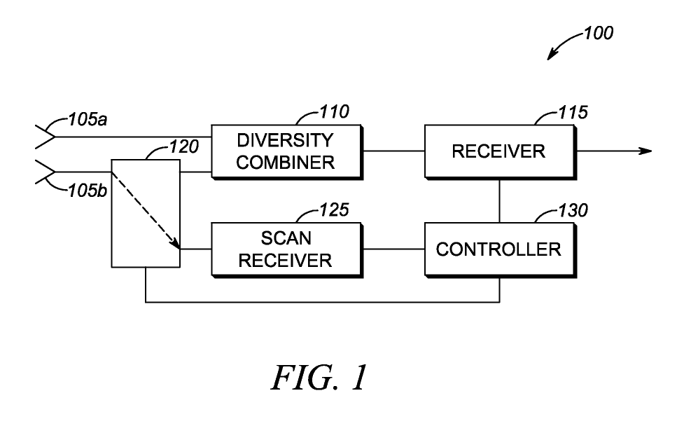

FIG. 1 is a block diagram of a wireless receiver 100, according to an embodiment of the present invention. The wireless receiver 100 advantageously comprises a 3rd Generation Partnership Project (3GPP) Long Term Evolution (LTE) receiver in the form of a data modem, cellular phone or other similar device. However, as will be readily understood by the one of ordinary skill in the art, other suitable standards can be used.

The wireless receiver 100 includes a first antenna 105a and a second antenna 105b, a Multiple Input Multiple Output (MIMO) combiner 110 and a receiver 115. The first antenna 105a is connected to the MIMO combiner 110 and the second antenna 105b is switchedly connected to the MIMO combiner 110 by a switching unit 120. Thus, the MIMO combiner 110 and the receiver 115 can receive a signal from both the first antenna 105a and the second antenna 105b, or the first antenna 105a only, according to a configuration of the switching unit 120.

The wireless receiver 100 additionally includes a scan receiver 125, switchedly connected to the second antenna 105b by the switching unit 120, which enables the second antenna 105b to be used for channel scanning.

Finally, the wireless receiver 100 includes a controller 130, for controlling the switching unit 120. The controller 130 is coupled to the receiver 115 and the scan receiver 125, and controls the switching unit 120 based upon signals of the receiver 115 and the scan receiver 125.

In use the first and second antennas 105a, 105b are typically both used to receive a first signal, which is combined in the MIMO combiner 110 and decoded in the receiver 115. The MIMO combiner 110 enables better quality wireless communication through use of both the first and second antennas 105a, 105b. In particular, the MIMO combiner 110 can, for example, combine signals of the first and second antennas 105a, 105b, or select a signal from one of the first and second antennas 105a, 105b having a highest signal quality indicator, such as a Channel Quality Indicator (CQI), a signal-to-noise ratio (SNR), a Received signal strength indication (RSSI), a Signal to Interference plus Noise Ratio (SINR), a Block Error Rate (BLER), a Bit Error Rate (BER), or any other suitable quality indicator.

The receiver 115 periodically, or when instructed, provides input to the controller 130 in the form of a signal quality indicator, such as a CQI, of the first signal. This enables the controller 130 to estimate a quality of the first signal if received using only the first antenna 105a. While the signal quality indicator referred to herein often is a CQI, one of ordinary skill in the art realizes that any suitable quality indicator may be used herein depending upon the wireless technology employed.

In certain circumstances, two-antenna reception improves the signal quality substantially, wherein in other circumstances it does not. Thus, the wireless receiver 100 can choose to use both the first and second antennas 105a, 105b when giving the most benefit, and otherwise use the second antenna 105b for scanning.

As discussed further below, other quality indicators such as Quality of Service (QoS) estimates of the first signal can be generated by the controller 130 to estimate a quality of the first signal if received using only the first antenna 105a. Additionally, in 3GPP LTE, for example, a bit rate can be negotiated between the wireless receiver 100 and an evolved Universal Mobile Telecommunications System (UMTS) Terrestrial Radio Access (E-UTRAN) Node B (eNB). In such case, the wireless receiver 100 can compare the negotiated bit rate with the traffic requirements to determine if a Rank Indication 1 (single stream) transmission is able to meet the QoS requirements.

If the CQI is sufficiently high, the controller 130 configures the switching unit 120 to receive the first signal using the first antenna 105a only, and configure the second antenna 105b to scan by connecting the second antenna 105b to the scan receiver 125.

According to certain embodiments, the CQI is determined by collecting statistics relating to the first and second antennas 105a, 105b. Such statistics can include coverage statistics from one or both of the first and second antennas 105a, 105b under different scenarios.

The scan receiver 125 and the second antenna 105b are then used to scan for a second signal while the receiver 115 receives and decodes the first signal using the first antenna 105a.

As discussed in further detail below, the wireless receiver 100 is advantageously configured to determine a CQI periodically, and perform scanning based thereon, such that the wireless receiver 100 is able to move back from a roaming network to a home network quickly when it becomes available. This is particularly important as the wireless receiver 100 moves as coverage will change based thereon.

According to certain embodiments, the first network is a public network, and the second network is a private network. The wireless receiver 100 is thus configured to enable efficient transfer back to the private network after transferring to the public network, for example when entering private network coverage again.

The present invention is particularly suited to public safety, wherein the private network is a dedicated public safety network and the public network is a commercial cellular network. In particular, the dedicated public safety network can be a 3GPP LTE BC14 network.

According to certain embodiments, the wireless receiver 100 continually evaluates the downlink reference signal quality and provides timely feedback reports to a connected base station, providing details on how to transmit data to the wireless receiver 100. In particular, the wireless receiver 100 can transmit one or more of: channel quality indicators (CQI), indicating spectral efficiency that the UE can support; a pre-coding matrix indicator (PMI), indicating a preferred codebook vector for transmission; and a rank indicator (RI), indicating a number of Multiple Input Multiple Output (MIMO) streams that a wireless receiver 100 can receive.

The wireless receiver 100 can selectively report “fake” data to the base station to enable use of one of the antennas 105a, 105b to scan other bands. In particular, when operating under very good or excellent rank 2 conditions, the wireless receiver 100 can periodically report rank 1 to the base station, and utilize the scan receiver 125 for a quick scan of alternate bands.

For example, a scan can be restricted to occur only in periods when rank 1 will permit current QoS requirements, and the length of the scan can be reduced to avoid lengthy signal quality degradation in case one antenna is no longer sufficient.

The wireless terminal 100 includes at least the two antennas 105a, 105b. However, as will be readily understood by the one of ordinary skill in the art, the teachings herein can be expanded to use more than the two antennas 105a, 105b. For example, LTE Release 10 supports eight antennas, and future derivatives of LTE could support more than eight antennas.

As will be readily understood by the one of ordinary skill in the art, wireless receivers according to various embodiments, such as the wireless receiver 100, will typically have both transmission and reception functionality. In this case, it is particularly advantageous that the wireless receiver includes a single transmitter and several receivers, such as between 2 and 8 receivers. This enables the wireless receiver to implement the methods described herein, without requiring two full transceivers.

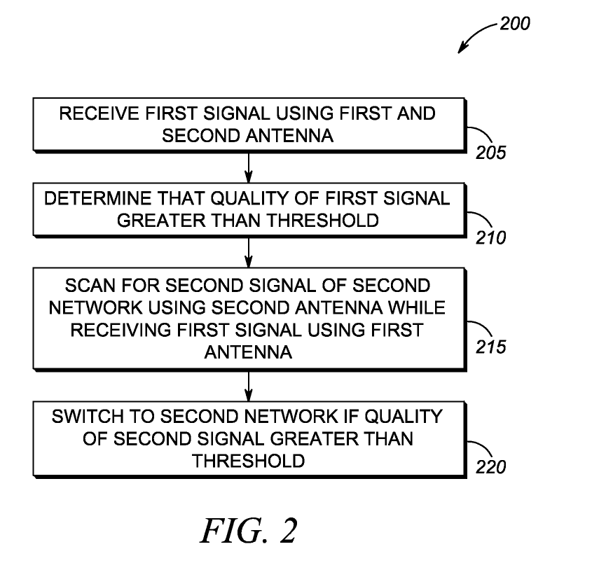

FIG. 2 illustrates a method 200 of controlling wireless receiver 100, according to an embodiment of the present invention. The wireless receiver includes first and second antennas and can, for example, be similar or identical to the wireless receiver 100 of FIG. 1.

In step 205, a first signal of a first network is received using both the first antenna and the second antenna. As discussed above, in certain circumstances diversity reception improves a signal quality of a signal substantially.

In step 210, it is determined that a quality of the first signal is greater than a first threshold quality. The first threshold quality can be static, and may correspond to a channel quality indicator (CQI), a Received signal strength indication (RSSI), a Signal to Interference plus Noise Ratio (SINR), a Block Error Rate (BLER), a Bit Error Rate (BER) or other suitable quality indicators, or dynamic and be updated according to current and/or previous network conditions, such as downlink traffic load QoS requirements.

As will be readily understood by the one of ordinary skill in the art, a quality of the first signal may initially be under the first threshold quality. In such case, determining the quality of the first signal is advantageously performed periodically while receiving the first signal from the first network.

According to certain embodiments, determining that the quality of the first signal is above the first threshold quality comprises determining that sufficient quality-of-service (QoS) can be achieved with respect to the first signal by using the first antenna and not using the second antenna. In such case, QoS indicators can comprise a combination of bit rate, packet loss and packet delay, or any other suitable measure.

In step 215, scanning for a second signal of a second network is performed using the second antenna and in response to determining that the quality of the first signal is greater than the first threshold quality. Simultaneously, the signal of the first network is received using the first antenna.

Scanning for the second signal of the second network can, for example, comprise determining a received signal strength indication (RSSI), Signal to Interference plus Noise Ratio (SINR); Reference Signal Received Power (RSRP) and Reference Signal Received Quality (RSRQ) of the signal of the second network. Alternatively or additionally, scanning for the second signal can comprise decoding a Physical Broadcast Channel (PBCH) and/or System Information Blocks (SIBs) of the signal of the second network. In such case, the receiver can determine a public land mobile network identifier of the second network, in order to identify the second network. The public land mobile network identifier can subsequently be used to determine if the second network has a higher priority than the first network.

According to certain embodiments, prior to scanning for the second signal on the second network, a request is sent to a base station of the first network to send data in a single stream and thus not utilize antenna diversity. The request can, for example, comprise reporting a Third Generation Partnership Project (3GPP) rank 1 to the base station.

In step 220, the wireless receiver switches to the second network if a quality of the second signal is greater than a second threshold quality. The second threshold quality need not be a single threshold value, but instead can comprise a plurality of parameters, each of which must be fulfilled, or of which a weighting is provided to each parameter.

If the quality of the second signal is lower than the second threshold quality, steps 205-220 are advantageously repeated periodically. This enables the wireless receiver to quickly move to another network as it becomes available.

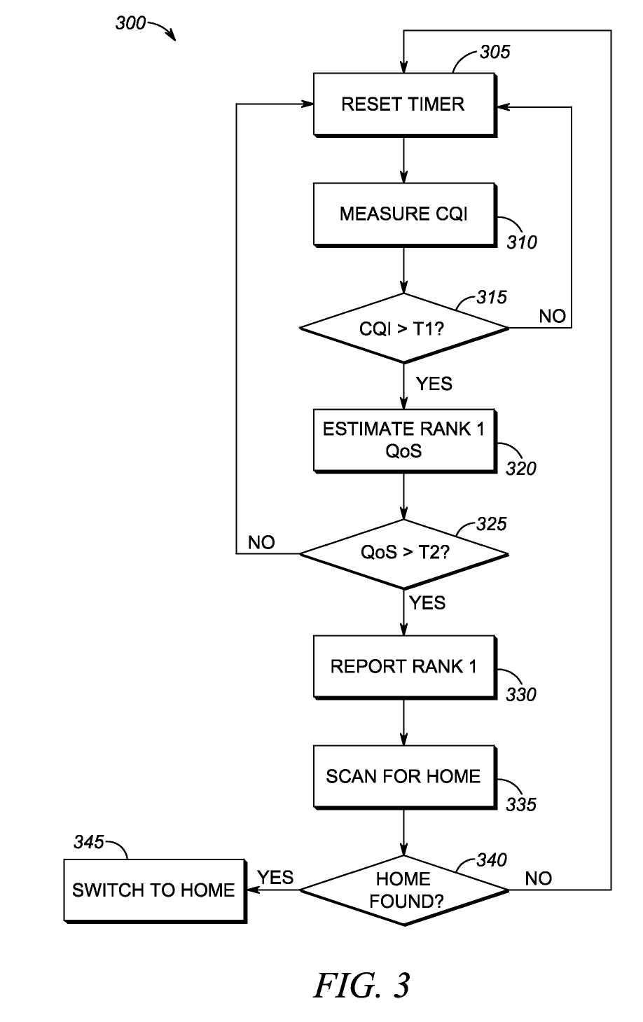

FIG. 3 illustrates a method 300 of controlling wireless receiver 100, according to an embodiment of the present invention. The method 300 is similar to the method 200 of FIG. 2, and is adapted to run on a wireless receiver that includes first and second antennas. The method 300 is particularly suited for assisting the wireless receiver to switch back to a home network from a roaming network.

In step 305 a timer is reset, which controls how often the wireless receiver attempts to scan for a home network while on the roaming network. If the timer is set to a small value, the wireless receiver will move back to the home network shortly after it becomes available again, but potentially results in decreased quality as the wireless receiver spends a large amount of time scanning with one of the antennas. Thus a balance between a small and large timer value can be an important factor according to some embodiments in determining QoS and performance.

In step 310, one or more signal quality indicators, such as Channel Quality Indicators (CQIs), are measured for the channel using both first and second antennas, and each of the first and second antennas individually.

Step 315 compares the one or more signal quality indicators, that is, the CQIs, with a first threshold value (T1) to determine if the CQI on a single antenna will permit the current traffic with associated QoS. If the one or more signal quality indicators are less than the first threshold value, the timer is reset in step 305 and the method 300 is started again.

If, however, the one or more signal quality indicators are greater than the first threshold value, rank 1 quality-of-service (QoS) is estimated in step 320. In this case, rank 1 refers to data transmission/reception using a single pair of antennas.

Step 325 compares the estimated rank 1 QoS with a second threshold value (T2). If the rank 1 QoS is less than the second threshold value, the timer is reset in step 305 and the method 300 is started again.

If, however, the estimated rank 1 QoS is greater than the second threshold value, rank 1 is reported to a base station to which the wireless receiver is connected in step 330. The wireless receiver reports rank 1 conditions to the base station, even though such conditions may not be strictly met, in order to force the base station to stop transmitting data in diversity mode.

In step 335, the wireless receiver scans for the home network using one of the antennas, while the other antenna continues to operate on the roaming network. Accordingly, sufficient quality is provided to the user through use of one of the antennas, while the other antenna is used for scanning

Step 340 determines if the home network is found. This can comprise determining that a signal quality indicator, for example, a signal strength, of the home network is greater than a particular threshold, or any other suitable means. If the home network is not found, the timer is reset in step 305 and the method 300 is started again. If, however, the home network is found, the wireless receiver switches to the home network in step 345.

According to alternative embodiments, several network categories are present to which the wireless receiver is able to connect. As discussed further below, the wireless receiver prioritizes among several networks and attempts to join the highest priority network available.

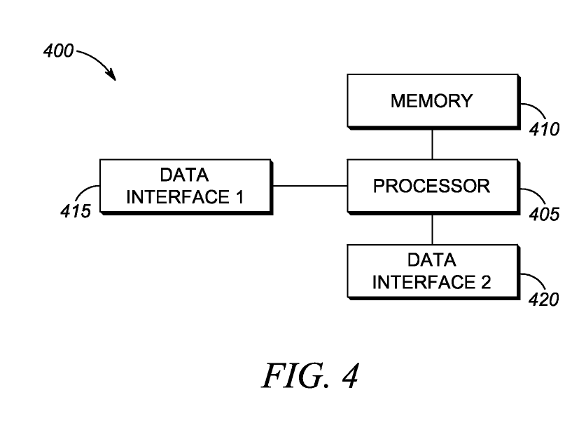

FIG. 4 is a block diagram of a controller 400, such as controller 130, of a wireless receiver, such as receiver 100, according to an embodiment of the present invention.

The controller 400 includes a processor 405, a memory 410 coupled to the processor 405, and first and second data interfaces 415, 420 coupled to the processor 405.

The first data interface 415 is for receiving input from a receiver, such as receiver 115, and/or a scan receiver, such as scan receiver 125, relating to signal quality information of respective signals and scan signals. Initially, the controller 400 receives signal quality information with respect to a first signal received using first and second antennas, such as antennas 105a and 105b, of the wireless receiver on the first data interface 415.

The memory 410 includes instruction code, executable by the processor 405, for determining if a quality of the first signal is greater than a threshold value. If the quality of the first signal is greater than a threshold value, scanning is initiated using the second antenna. Scanning is initiated using the second antenna by the processor 405 sending a control message to a switching controller, such as switching unit 120, on the second data interface 420.

According to certain embodiments, the memory 410 includes a channel prioritization list, which is used to prioritize channels prior to channel switching. This enables the controller 400 to selectively switch between channels in order to remain at the highest priority channel switch available.

The controller 400 then receives signal quality information with respect to a second signal received using the second antenna of the wireless receiver on the first data interface 415. Based upon the signal quality information with respect to a second signal, the processor 405 determines if the signal quality of the second signal is sufficiently high.

If the signal quality of the second signal is sufficiently high, the controller 400 instructs the wireless receiver to switch networks.

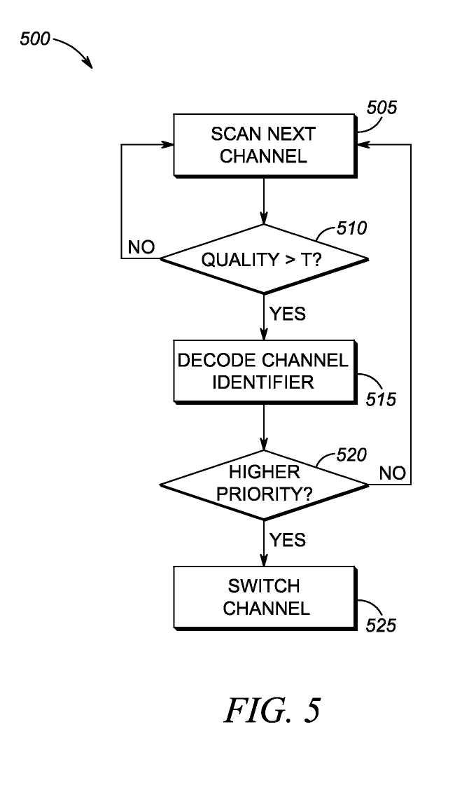

FIG. 5 illustrates a method 500 of scanning for channels by wireless receiver 100, according to an embodiment of the present invention. The method 300 of FIG. 3 can be adapted to include the method 500 in place of step 335. In such case, channel priorities are used to determine if a channel switch should be performed, rather than a binary decision between a home network and a roaming network.

In step 505, the wireless receiver, such as the wireless receiver 100, scans for an alternative network using one of its antennas, while the other antenna or antennas continue to operate on the present network. Scanning for the alternative network can comprise sequentially scanning a list of channels on a scan list, or across a frequency band.

In step 510, a quality of the channel is determined or estimated, and compared with a threshold quality. A quality of the channel can be measured according to a received signal strength indicator (RSSI) of a signal of the channel, or any other suitable signal quality indicator. If the quality of the channel is less than the threshold quality, scanning is again performed in step 505.

If the quality of the channel is greater than the threshold quality, in step 515 a channel identifier is decoded from the channel. The channel identifier of the channel can be identified by decoding a physical broadcast channel (PBCH) and/or system information blocks (SIBs) of the signal of the channel. Subsequently, a public land mobile network identifier of the channel can be determined, which is an example of a channel identifier. Further, as will be readily understood by the one of ordinary skill in the art, the channel identifier need not be unique for a particular channel, and instead can identify a group of channels.

In step 520, a priority of the (scanned) channel is determined Further, if not already determined, a priority of a channel currently being used to receive traffic also is determined If the priority of the scanned channel is lower than the priority of the channel currently being used to receive traffic, then scanning is again performed in step 505. If the priority of the scanned channel is higher than the priority of the channel currently being used to receive traffic, then the wireless receiver switches to the home network in step 525.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of controlling a wireless receiver including first and second antennas, the method comprising:
receiving a first signal of a first network using both a first antenna and a second antenna;
determining that a quality of the first signal is greater than a first threshold quality;
in response to determining that the quality of the first signal is greater than the first threshold quality, scanning for a second signal of a second network using the second antenna while receiving the signal of the first network using the first antenna; and
switching to the second network if a quality of the second signal is greater than a second threshold quality.

2. The method of claim 1, wherein determining that the quality of the first signal is above the first threshold quality comprises determining that sufficient quality-of-service can be achieved with respect to the first signal by using the first antenna and not using the second antenna.

3. The method of claim 1, further comprising: prior to scanning for the second signal on the second network, requesting a base station of the first network to send data in a single Multiple Input Multiple Output (MIMO) stream.

4. The method of claim 3, wherein requesting the base station to send data on a single MIMO stream comprises reporting a Third Generation Partnership Project (3GPP) rank 1 to the base station.

5. The method of claim 1, wherein determining that the quality of the first signal is above a threshold and scanning for a second signal of a second network is performed periodically while receiving the first signal from the first network.

6. The method of claim 1, wherein the first network is a public network, and the second network is a private network.

7. The method of claim 6, wherein the private network is a 3GPP BC14 network.

8. The method of claim 1, wherein scanning for the signal of the second network comprises determining a received signal strength indication (RSSI), a Signal to Interference plus Noise Ratio (SINR); Reference Signal Received Power (RSRP) or a Reference Signal Received Quality (RSRQ) of the signal of the second network.

9. The method of claim 1, wherein scanning for the signal of the second network comprises decoding a Physical Broadcast Channel (PBCH) and/or System Information Blocks (SIBs) of the signal of the second network.

10. The method of claim 9, further comprising
determining a public land mobile network identifier of the second network; and
determining, according to the public land mobile network identifier of the second network, that the second network has a higher priority than the first network.

11. The method of claim 1, wherein the wireless receiver is a 3GPP long term evolution (LTE) terminal.

12. A wireless receiver comprising:
a first antenna;
a second antenna; and
a controller, the controller including a processor and a memory coupled to the processor, the memory including instruction code executable by the processor for:
configuring the wireless receiver to receive a first signal of a first network using both the first antenna and the second antenna;
determining that a quality of the first signal is greater than a first threshold quality;
in response to determining that the quality of the first signal is greater than the first threshold quality, scanning for a second signal of a second network using the second antenna while receiving the signal of the first network using the first antenna; and
configuring the wireless receiver to switch to the second network if a quality of the second signal is greater than a second threshold quality.

13. The wireless receiver of claim 12, wherein determining that the quality of the first signal is above the first threshold quality comprises determining that sufficient quality-of-service can be achieved with respect to the first signal by using the first antenna and not using the second antenna.

14. The wireless receiver of claim 12, wherein the memory further includes instruction code for: prior to scanning for the second signal on the second network, requesting a base station of the first network to send data in a single Multiple Input Multiple Output (MIMO) stream.

15. The wireless receiver of claim 14, wherein requesting the base station to send data on a single MIMO stream comprises reporting a Third Generation Partnership Project (3GPP) rank 1 to the base station.

16. The wireless receiver of claim 12, wherein determining that the quality of the first signal is above a threshold and scanning for a second signal of a second network is performed periodically while receiving the first signal from the first network.

17. The wireless receiver of claim 12, wherein the first network is a public network, and the second network is a private network.

18. The wireless receiver of claim 17, wherein the private network is a 3GPP BC14 network.

19. The wireless receiver of claim 12, wherein scanning for the signal of the second network comprises determining a received signal strength indication (RSSI), a Signal to Interference plus Noise Ratio (SINR); Reference Signal Received Power (RSRP) or a Reference Signal Received Quality (RSRQ) of the signal of the second network.

20. The method of claim 12, wherein scanning for the signal of the second network comprises decoding a Physical Broadcast Channel (PBCH) and/or System Information Blocks (SIBs) of the signal of the second network.
